(19) United States
(12) Patent Application Publication
(10) Pub. No.: US 2006/0196476 A1
(43) Pub. Date: Sep. 7, 2006

(54) Pressure relief valve

(75) Inventor: Alan R. Stockner, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/067,273

(22) Filed: Feb. 28, 2005

(51) Int. Cl. F02M 57/02; G05D 11/00; F02M 69/54

(52) U.S. Cl. 123/457; 123/446; 137/115.04

(57) ABSTRACT

A pressure relief valve includes a valve body defining an inlet configured to receive fluid from a fluid system, a pressure control orifice ending in a valve seat, and a guideway extending from the valve seat. The pressure relief valve further includes a valve closing member configured to abut the valve seat in a closed position and to be displaced from the valve seat in an open position, thereby releasing pressure from the fluid system. The pressure relief valve also includes a flow member including a stem and a flow plate. The stem is operably associated with the valve closing member and is configured to reciprocate within the guideway. The pressure relief valve further includes a valve spring operably associated with the valve body.

### TECHNICAL FIELD

The present disclosure relates generally to a pressure relief valve and, more particularly, to a pressure relief valve having a pressure control orifice.

### BACKGROUND

In many fluid system applications, it may be desirable to relieve pressure in the fluid system, for example, in order to prevent damage to components of the fluid system and/or in order to prevent an abnormal condition. For example, a combustion engine may include a fuel system for supplying fuel to combustion chambers under pressure in order to provide appropriate atomization and mixing of combustion components. An example of one such fuel system is commonly referred to as a common rail fuel injection system.

In a common rail fuel injection system, a pump, for example, a variable displacement pump, supplies fuel under high pressure, such as, for example, about 1,600 bar, to a manifold sometimes referred to as a common rail, which provides fuel to injectors associated with each of the combustion chambers. Under certain circumstances, the pressure in the fuel system may reach a magnitude that could damage the components of the fuel system.

In order to prevent such an occurrence, the fuel system may be provided with a pressure relief valve configured to relieve pressure in the fuel system when it reaches a magnitude above a maximum desired level (e.g., when an overpressure condition occurs). For example, a high pressure relief valve may be selected to relieve pressure once it reaches a magnitude of about 2,000 bar. Furthermore, in high pressure fuel systems, it may be desirable to provide relatively stable pressure relief. In particular, it may be generally desirable for a high pressure relief valve to operate such that it does not generate broad oscillations in fluid system pressure as it opens and closes in response to pressure increases and drops, respectively.

In order to provide a relatively stable operation, some conventional pressure relief valves have complex valve seat and valve closing member configurations. Such complex valve seat and valve closing member configurations, however, may be more expensive than desired.

One alternative pressure relief valve that is less expensive is a pressure relief valve having a ball-shaped valve closing member. This less complex and generally less expensive valve closing member, however, may be unsuitable due to its relatively unstable pressure relief characteristics. In particular, a pressure relief valve having a ball-shaped valve closing member may include a pressure relief aperture for releasing fluid pressure, which may be closed by the valve closing member that is associated with a spring configured to resist pressure of the fluid and hold the valve closing member in a position obstructing the aperture. When pressure in the fluid system reaches a magnitude high enough to overcome the force of the spring holding the valve closing member over the aperture, the valve closing member is displaced to allow fluid to flow through the aperture, thereby releasing pressure.

In such an arrangement, however, once the pressure in the fluid system has been released by virtue of the ball-shaped valve closing member being unseated and displaced to release pressure, in order for the valve closing member to reseat and discontinue pressure relief, pressure in the fluid system may need to drop to an undesirably low magnitude because the fluid flowing through the aperture, once opened, prevents the ball-shaped valve closing member from reseating until the pressure drops significantly. Such a significant pressure drop, however, may prevent the fluid system from operating properly. For example, in a fuel system for a combustion engine, if the pressure in the fuel system drops too much, the combustion engine may not be able to receive enough fuel to operate properly. In particular, the pressure relief may be unstable and/or unsuitable because the pressure in the fluid system will tend to oscillate back and forth between an undesirably high pressure and an undesirably low pressure, thereby possibly hindering the desired operation of the fluid system and/or creating undesirable stresses on the components of the fluid system due to rapid pressure changes.

One pressure relief valve for relieving pressure in a fluid system is described in U.S. Pat. No. 6,675,774 (the '774 patent) issued to Frank et al. on Jan. 13, 2004. The '774 patent describes a pressure relief valve, which is integrated with a fuel reservoir for supplying fuel to a number of injectors. The pressure relief valve includes a ball-shaped valve body. Although the pressure relief valve described in the '774 patent may relieve higher than desired pressure, it does not provide stable pressure relief of the fluid system since it suffers from the above-mentioned problems.

The disclosed pressure relief valve, on the other hand, may overcome one or more of the problems set forth above.

### SUMMARY OF THE INVENTION

In one aspect, the present disclosure is directed to a pressure relief valve that includes a valve body defining an inlet configured to receive fluid from a fluid system. The inlet defines a cross-sectional area. The valve body further includes a pressure control orifice ending in a valve seat. The pressure control orifice defines a cross-sectional area less than the cross-sectional area of the inlet. The valve body also includes a guideway extending from the valve seat. The pressure relief valve further includes a valve closing member configured to abut the valve seat in a closed position and to be displaced from the valve seat in an open position, thereby releasing pressure from the fluid system. The pressure relief valve also includes a flow member including a stem and a flow plate. The stem is operably associated with the valve closing member and is configured to reciprocate within the guideway. The pressure relief valve further includes a valve spring operably associated with the valve body. The valve spring is configured to exert a biasing force to hold the valve closing member via the flow plate against the valve seat in the closed position and to return the valve closing member to the closed position when the valve closing member is in the open position.

In another aspect, the present disclosure is directed to a fluid system that includes a pump configured to pressurize a fluid and a pressure relief valve configured to regulate pressure in the fluid system. The pressure relief valve includes a valve body defining an inlet configured to receive fluid from a fluid system. The inlet defines a cross-sectional area. The valve body further includes a pressure control orifice ending in a valve seat. The pressure control orifice defines a cross-sectional area less than the cross-sectional area of the inlet. The valve body also includes a guideway extending from the valve seat. The pressure relief valve further includes a valve closing member configured to abut the valve seat in a closed position and to be displaced from the valve seat in an open position, thereby releasing pressure from the fluid system. The pressure relief valve also includes a flow member including a stem and a flow plate. The stem is operably associated with the valve closing member and is configured to reciprocate within the guideway. The pressure relief valve further includes a valve spring operably associated with the valve body. The valve spring is configured to exert a biasing force to hold the valve closing member via the flow plate against the valve seat in the closed position and to return the valve closing member to the closed position when the valve closing member is in the open position.

In still another aspect, the present disclosure is directed to a common rail fuel system for providing pressurized fuel to a combustion engine. The system includes a pump configured to pressurize fuel and a pressure relief valve configured to regulate pressure in the system. The pressure relief valve includes a valve body defining an inlet configured to receive fluid from a fluid system. The inlet defines a cross-sectional area. The valve body further includes a pressure control orifice ending in a valve seat. The pressure control orifice defines a cross-sectional area less than the cross-sectional area of the inlet. The valve body also includes a guideway extending from the valve seat. The pressure relief valve also includes a valve closing member configured to abut the valve seat in a closed position and to be displaced from the valve seat in an open position, thereby releasing pressure from the fluid system. The pressure relief valve further includes a flow member including a stem and a flow plate. The stem is operably associated with the valve closing member and is configured to reciprocate within the guideway. The pressure relief valve also includes a valve spring operably associated with the valve body. The valve spring is configured to exert a biasing force to hold the valve closing member via the flow plate against the valve seat in the closed position and to return the valve closing member to the closed position when the valve closing member is in the open position.

### BRIEF DESCRIPTION OF THE DRAWINGS

FIG. 1 is a schematic diagram of an exemplary fluid system.

FIG. 2 is a schematic, partial cross-sectional view of an exemplary embodiment of a pressure relief valve.

FIG. 3 is a schematic, partial cross-sectional view of a portion of the exemplary embodiment shown in FIG. 2.

FIG. 3A is a schematic, partial view of section A-A of FIG. 3.

FIG. 4A is a schematic, partial cross-sectional view of an exemplary embodiment of a pressure relief valve shown in a closed condition.

FIG. 4B is a schematic, partial cross-sectional view of an exemplary embodiment of a pressure relief valve shown in a fully open condition.

FIG. 4C is a schematic, partial cross-sectional view of an exemplary embodiment of a pressure relief valve shown in a partially open condition.

### DETAILED DESCRIPTION

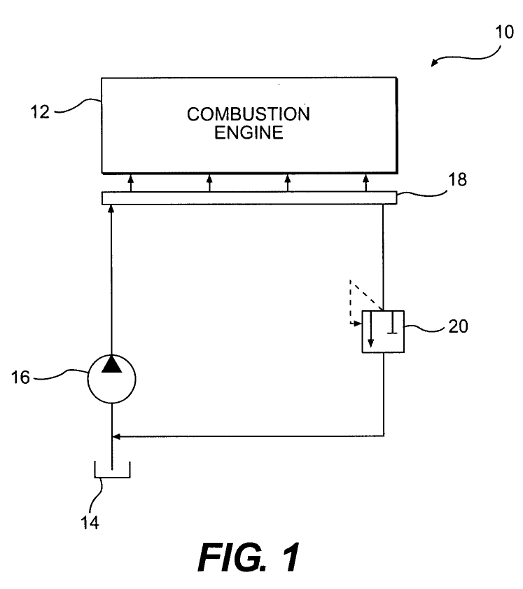

FIG. 1 illustrates an exemplary fluid system 10. Fluid system 10 is a fuel system for delivering fuel to a combustion engine 12, which may include a reservoir 14 for storing fuel, and a pump 16 for transferring fuel from reservoir 14 to combustion engine 12 via a manifold 18. Fuel system 10 may be configured to deliver fuel to combustion engine 12 under pressure, for example, ranging from about 300 bar to about 2,000 bar (e.g., from about 1,000 bar to about 2,000 bar (e.g., about 1,600 bar)). In order to prevent pressure in the fluid system 10 from reaching an undesirably high magnitude, fluid system 10 may be provided with a pressure relief valve 20, for example, a high pressure relief valve. Although fluid system 10 has been described for exemplary purposes in relation to a fuel system, principles contained in this disclosure may have application to other fluid systems known to those having skill in the art.

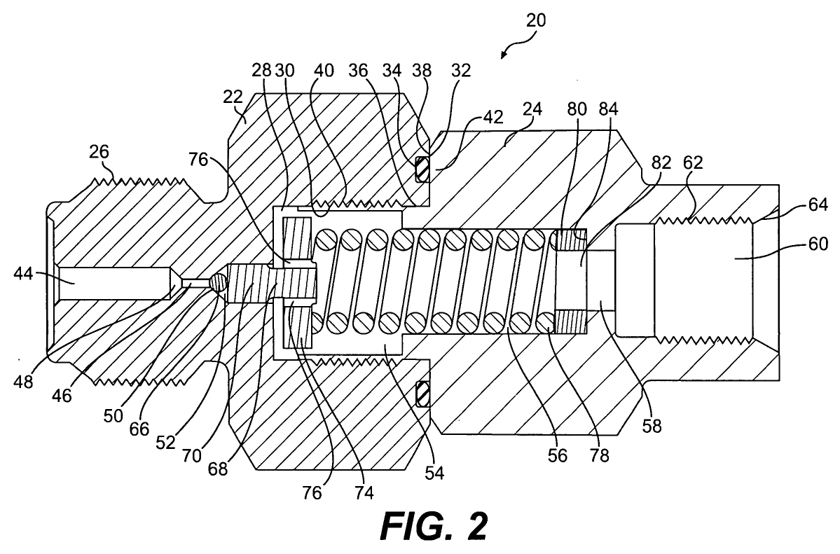

FIG. 2 illustrates an exemplary pressure relief valve 20, for example, a high pressure relief valve, for use in a fluid system in order to regulate pressure in the fluid system. Other uses of pressure relief valve 20 known to those having skill in the art are contemplated. According to some embodiments, pressure relief valve 20 may include a valve body 22 and a valve end portion 24. Valve body 22 may be configured to be fitted into a portion of a fluid system via, for example, an external thread 26 provided on valve body 22. Valve body 22 may further include a bore 28 provided with an internal thread 30 and a shoulder 32 defining an annular recess 34. Valve end portion 24 may include a neck portion 36 defining a shoulder 38. Neck portion 36 may be provided with an external thread 40. When assembled, valve end portion 24 may be threaded into bore 28 of the valve body 22 via threaded engagement between internal thread 30 and external thread 40 until shoulder 32 of valve body 22 and shoulder 38 of valve end portion 24 abut one another. An O-ring seal 42 may be provided in recess 34 such that the connection between valve body 22 and valve end portion 24 is substantially fluid tight. Rather than (or in addition to) providing recess 34 in shoulder 32 of valve body 22, an annular recess may be provided in shoulder 38 of valve end portion 24.

Valve body 22 may include an inlet 44 configured to be in flow communication with a fluid system. Inlet 44 may, in turn, be in flow communication with a pressure control orifice 46. Inlet 44 may be dimensioned to have a larger cross-sectional area than pressure control orifice 46, and a chamfer 48 may be provided between inlet 44 and pressure control orifice 46. Pressure control orifice 46 may terminate at a valve seat 50, which, in turn, provides flow communication between pressure control orifice 46 and a guideway 52, which is in flow communication with bore 28 of valve body 22.

Valve end portion 24 may define a first bore 54 and a second bore 56, each defining a substantially smooth cylindrical interior surface. Valve end portion 24 may also define a third bore 58 in flow communication with second bore 56 and an exit bore 60. Exit bore 60 may include an internal thread 62 for threadedly receiving, for example, a return line for passing fluid back into the fluid system upon opening of exemplary pressure relief valve 20. Exit bore 60 may terminate in a chamfered portion 64.

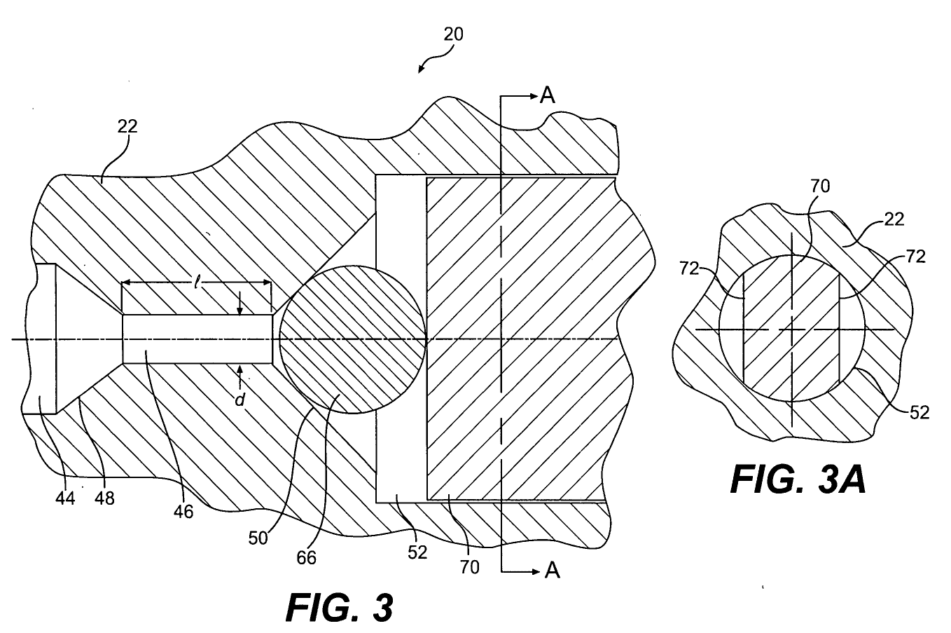

As illustrated in FIG. 3, pressure control orifice 46 defines a length dimension l and a diameter dimension d. Length dimension l may be measured from an end of chamfer 48 adjacent pressure control orifice 46 to valve seat 50 located at the end of pressure control orifice 46. Length dimension l and diameter dimension d may be selected based on a relationship such that fluid flowing from inlet 44 through pressure control orifice 46 undergoes cavitation as the fluid passes through pressure control orifice 46 and contains a cavitation field (e.g., a fully developed cavitation field) as it exits pressure control orifice 46 at valve seat 50 and enters guideway 52. Diameter dimension d may be constant over substantially the entire length dimension l, although it is contemplated that diameter dimension d may vary along the length dimension l, so long as fluid flowing from the inlet 44 through pressure control orifice 46 experiences cavitation as the fluid exits pressure control orifice 46 at valve seat 50. For example, length dimension l and diameter dimension d may be related in a ratio ranging from about 2 to 1 to about 5 to 1 (e.g., about 4 to 1), respectively. For example, length dimension l may be about 3.25 millimeters and diameter dimension d may be about 0.75 millimeter. This relationship and these dimensions are merely exemplary and other relationships and dimensions determinable by those having skill in the art are contemplated.

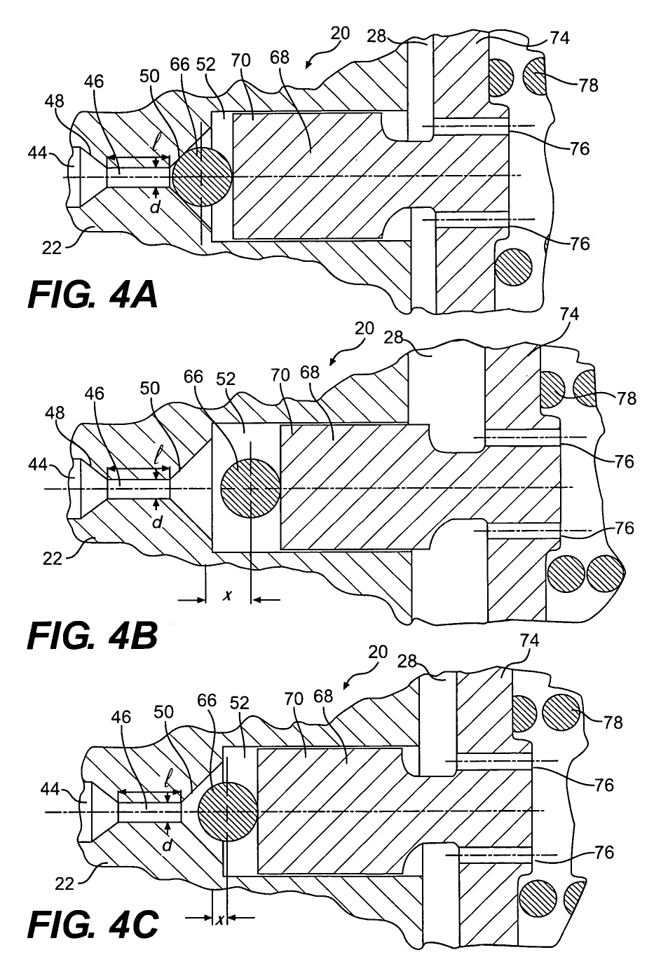

Pressure relief valve 20 may further include a valve closing member 66, for example, a ball-shaped valve closing member, and a flow member 68. Flow member 68 may include a stem 70 configured to reciprocate within guideway 52. Stem 70 and guideway 52 may be configured to prevent flow member 68 from becoming misaligned and/or bound-up within first bore 54 of valve end portion 24. For example, guideway 52 may define a substantially constant cross-sectional area and stem 70 may be shaped and dimensioned to prevent stem 70 from becoming misaligned and/or bound-up within guideway 52. Stem 70 may include one or more passages, for example, defined by one or more recessed surfaces 72 (e.g., as shown in FIG. 3A), providing flow communication between guideway 52 and bore 28 of valve body 22. Flow member 68 may further include a flow plate 74 (see, for example, FIGS. 2 and 4A-4C) defining one or more apertures 76 (e.g., four apertures) configured to provide flow communication between bore 28 of valve body 22 and first bore 54 of valve end portion 24. Valve closing member 66 and flow member 68 are configured such that valve closing member 66 abuts stem 70 of flow member 68 and such that valve closing member 66 seats against valve seat 50 at the exit of pressure control orifice 46.

Referring to FIG. 2, pressure relief valve 20 may further include a spring 78 and a shim 80 configured to provide a biasing force against flow plate 74 such that valve closing member 66 such that valve closing member 66 is seated against valve seat 50. Shim 80 may define one or more apertures 82 and may be configured to seat in an end of second bore 56 opposite first bore 54 defined by a shoulder 84. Spring 78 may be compressed between flow plate 74 and shim 80.

### INDUSTRIAL APPLICABILITY

The disclosed pressure relief valve may be applicable to any fluid system such as, for example, a fuel system, a hydraulic system, or any other system known in the art where use of a pressure relief valve may be desired. Pressure relief valve 20 may provide a simple, inexpensive solution for reducing the cost and/or complexity of pressure relief valves configured to be used in a relatively high pressure environment, such as, for example, a common rail fuel injection system for a combustion engine.

For example, in the exemplary fluid system 10 schematically depicted in FIG. 1, pump 16 delivers fuel under pressure from reservoir 14 to combustion engine 12 via manifold 18. For example, fluid system 10 may be configured to operate at pressures ranging from about 300 bar to about 2,000 bar (e.g., from about 1,000 bar to about 2,000 bar (e.g., about 1,600 bar)). Pressure relief valve 20 may be a high pressure relief valve and may be configured to prevent the pressure in fluid system 10 from reaching an overpressure condition (e.g., a magnitude above a predetermined, maximum desired pressure, such as, for example, about 2,000 bar). Once pressure in fluid system 10 reaches a maximum desired pressure, pressure relief valve 20 may be configured to relieve pressure until the magnitude of the pressure drops to a level below the maximum desired pressure.

Referring to FIG. 2, pressure relief valve 20 may be fitted into a portion of a fluid system via, for example, an external thread 26 provided on valve body 22, such that pressure relief valve 20 is in flow communication with the fluid system, such as, for example, fluid system 10 shown in FIG. 1. So long as the pressure in the fluid system remains below a maximum desired pressure, pressure relief valve 20 maintains a fully closed condition in which valve closing member 66 remains seated in valve seat 50, for example, as schematically depicted in FIG. 4A.

When pressure in the fluid system reaches a magnitude greater than a maximum desired pressure, fluid from the fluid system located in inlet 44 and pressure control orifice 46 presses against valve closing member 66 with enough force to displace valve closing member 66, thereby overcoming a biasing force supplied by spring 78 via flow plate 74, for example, such that pressure relief valve 20 is in a fully open condition, for example, as schematically depicted in FIG. 4B.

As valve closing member 66 becomes displaced a distance x, fluid from the fluid system is allowed to pass between valve seat 50 and valve closing member 66, and into guideway 52. Once in guideway 52, fluid may pass through one or more passages, for example, defined by recessed surfaces 72, in stem 70 and into bore 28. Once in bore 28, fluid may travel through one or more apertures 76 in flow plate 74 and into first bore 54, through second bore 56 and third bore 58, and out exit bore 60 of valve end portion 24, thereby reducing pressure in the fluid system.

By allowing fluid to flow across pressure relief valve 20, pressure may be reduced in the fluid system to a magnitude below the maximum desired pressure. The biasing force provided by spring 78 is due to its amount of compression, which is about equal to the displacement distance x of valve closing member 66. As fluid flows across pressure relief valve 20, the force of the fluid acting on valve closing member 66 becomes reduced as the pressure in the fluid system drops. As the fluid force is reduced, the biasing force of spring 78 counteracts the fluid force applied against valve closing member 66 and reduces the displacement x of valve closing member 66 until an equilibrium is reached between the fluid force and the biasing force of spring 78. As a result, pressure relief valve 20 may take on a partially open condition, for example, such as schematically depicted in FIG. 4C.

So long as the fluid system continues to operate in such a manner that would result in a fluid system pressure that is higher than a maximum desired fluid system pressure in the absence of pressure relief, a sufficient amount of fluid may continue to flow across pressure relief valve 20 to prevent valve closing member 66 from completely reseating on valve seat 50 and completely closing pressure relief valve 20. Furthermore, pressure control orifice 46 defines a length dimension l and a diameter dimension d, which may be selected based on a relationship such that fluid flowing from the inlet 44 through pressure control orifice 46 experiences cavitation as the fluid exits pressure control orifice 46. When the length dimension l and the diameter dimension d of pressure control orifice 46 have a relationship such that cavitation occurs in the flow of the fluid as the fluid exits valve seat 50, a cavitation field that creates voids in the fluid flow is formed such that valve closing member 66 is exposed to at least a portion of the cavitation field and experiences a reduced force due to the fluid relative to the force that would occur without cavitation. Due to the relatively reduced force of the fluid experiencing cavitating flow against valve closing member 66, valve closing member 66 may either move to a position of relatively reduced displacement x (see, for example, FIG. 4C) or may return and seat in valve seat 50 (see, for example, FIG. 4A) at a relatively higher fluid system pressure than if valve closing member 66 were experiencing an opening force due to fluid flowing absent cavitation. In particular, since cavitating fluid flow includes voids, valve closing member 66 has a reduced resistance to the fluid flow relative to fluid flow lacking cavitation. Because of this relatively reduced resistance, the force of the fluid flow holding valve closing member 66 off of valve seat 50 is reduced for a given pressure in the fluid system relative to fluid flow absent cavitation. As result, valve closing member 66 will tend to return toward valve seat 50 such that pressure relief valve 20 allows the fluid system to continue to operate at an acceptable fluid system pressure (e.g., a fluid system pressure lower than the maximum desired fluid system pressure, but high enough to continue operating with an acceptable steady-state performance).

By virtue of operating in a partially open condition, pressure relief valve 20 may provide a more stable control of the pressure in the fluid system. For example, if the maximum desired fluid system pressure is about 2,000 bar, once the pressure in the fluid system reaches 2,000 bar, valve closing member 66 displaces off valve seat 50 by virtue of the fluid pressure force overcoming the biasing force due to spring 78. Once valve closing member 66 has been displaced, fluid flows through pressure control orifice 46 and exits at valve seat 50. Due to the relationship between length dimension l and diameter dimension d, the fluid exiting at valve seat 50 experiences cavitation, thereby creating voids. Due to the voids, there is less force acting against the biasing force of spring 78 than if the fluid were not experiencing cavitation upon exit at valve seat 50. Since there is relatively less force holding valve closing member 66 off of valve seat 50, less pressure drop in the fluid system is required before valve closing member 66 either returns to a partially open condition (for example, as shown in FIG. 4C) or returns to a fully closed condition such that valve closing member 66 seats against valve seat 50 and ceases pressure relief of the fluid system, for example, as shown in FIG. 4A. Since the pressure drop is less, the pressure in the fluid system may experience a relatively reduced magnitude of fluctuation, thereby rendering the pressure relief more stable.

By virtue of having a more stable pressure relief, the fluid system may continue to operate in an acceptable manner even when pressure relief valve 20 is opened by repeated occurrences of pressures exceeding the maximum desired pressure in the fluid system. For example, in a fuel system for a combustion engine generally configured to operate at pressures ranging from about 300 bar to about 2,000 bar (e.g., about 1,000 bar to about 2,000 bar), certain conditions may occur that result in the pressure in the fuel system reaching 2,000 bar, thereby necessitating pressure relief valve 20 to open and relieve the overpressure condition. If these certain conditions persist or occur repeatedly, pressure relief valve 20 may experience repeated cycling between being fully open (see, for example, FIG. 4B) to relieve pressure and closed once the pressure has dropped to an acceptable level. In order for the fuel system to provide fuel at a high enough and/or stable enough pressure to continue operating the combustion engine in a desired manner, however, at least a certain minimum operating pressure must be maintained in the fuel system. Therefore, pressure relief valve 20 may be configured to discontinue pressure relief prior to the pressure in the fuel system dropping below the minimum operating pressure. By virtue of having a pressure control orifice that reduces the amount of pressure drop required for valve closing member 66 to either return to a partially open condition or return to valve seat 50, pressure relief valve 20 may either reduce or discontinue pressure relief at a fluid system pressure higher than the minimum operating pressure of the fluid system, so that the combustion engine can continue to be operated in an acceptable manner.

Furthermore, by virtue of the fluid flow exerting less force on valve closing member 66 when pressure relief valve 20 is relieving pressure, less biasing force to counteract the fluid force may be required. As a result, spring 78 may be selected to have a relatively reduced spring rate, thereby possibly reducing the stress on spring 78. In addition, by virtue of having a reduced spring rate, the service life of valve closing member 66 and/or valve seat 50 may be improved due to reduced impact force when valve closing member 66 returns to valve seat 50.

According to the exemplary embodiment shown in FIG. 2, pressure relief valve 20 may be configured to relieve pressure in a fluid system at a predetermined magnitude of pressure by at least one of selecting spring 78 having a particular spring rate and selecting shim 80 having a particular thickness. For example, the amount of biasing force spring 78 applies against flow plate 74 may be established by selecting a spring having a particular spring rate and/or by preloading spring 78 by selecting shim 80 having a thickness such that spring 78 has a desired amount of preload biasing force.

It will be apparent to those skilled in the art that various modifications and variations can be made to the disclosed pressure relief valve. For example, although the pressure relief valve has been described in relation to a fuel system, the pressure relief valve may be used in conjunction with other fluid systems that may benefit from pressure relief. Other embodiments will be apparent to those skilled in the art from consideration of the specification and practice of the disclosed pressure relief valve. It is intended that the specification and examples be considered as exemplary only, with a true scope being indicated by the following claims and their equivalents.

What is claimed is:

1. A pressure relief valve comprising:
a valve body defining
an inlet configured to receive fluid from a fluid system, the inlet defining a cross-sectional area,
a pressure control orifice ending in a valve seat, the pressure control orifice defining a cross-sectional area less than the cross-sectional area of the inlet, and
a guideway extending from the valve seat;
a valve closing member configured to abut the valve seat in a closed position and to be displaced from the valve seat in an open position, thereby releasing pressure from the fluid system;
a flow member including a stem and a flow plate, the stem being operably associated with the valve closing member and being configured to reciprocate within the guideway; and
a valve spring operably associated with the valve body, the valve spring being configured to exert a biasing force to hold the valve closing member via the flow plate against the valve seat in the closed position and to return the valve closing member to the closed position when the valve closing member is in the open position.

2. The pressure relief valve of claim 1, wherein the pressure control orifice is configured to reduce the biasing force necessary to return the valve closing member to the closed position.

3. The pressure relief valve of claim 1, wherein the pressure control orifice defines a length dimension and a diameter dimension, and wherein the length dimension and the diameter dimension are related in a ratio ranging from about two to one to about five to one.

4. The pressure relief valve of claim 1, wherein the pressure control orifice is configured such that once the valve closing member is in the open position, the fluid flowing through the pressure control orifice cavitates, thereby creating a cavitation field that creates voids in the fluid flowing through the pressure control orifice such that the valve closing member is exposed to at least a portion of the cavitation field.

5. The pressure relief valve of claim 1, wherein the pressure relief valve is a high pressure relief valve.

6. The pressure relief valve of claim 1, wherein the flow plate includes at least one aperture configured to allow fluid flow across the pressure relief valve.

7. The pressure relief valve of claim 1, wherein the stem defines at least one passage configured to provide flow communication between the pressure control orifice and the flow plate via the guideway.

8. The pressure relief valve of claim 1, wherein the valve closing member is formed as a separate piece from the flow member.

9. The pressure relief valve of claim 8, wherein the valve closing member is substantially ball-shaped.

10. The pressure relief valve of claim 1, wherein the guideway defines a substantially constant cross-section.

11. The pressure relief valve of claim 1, wherein the stem defines a portion configured to reciprocate within the guideway, the portion defining a substantially constant cross-section.

12. The pressure relief valve of claim 1, wherein the guideway and the stem are configured such that the stem reciprocates within the guideway without becoming misaligned within the guideway.

13. A fluid system comprising:
a pump configured to pressurize a fluid;
a pressure relief valve configured to regulate pressure in the fluid system, the pressure relief valve including
a valve body defining
an inlet configured to receive fluid from a fluid system, the inlet defining a cross-sectional area,
a pressure control orifice ending in a valve seat, the pressure control orifice defining a cross-sectional area less than the cross-sectional area of the inlet, and
a guideway extending from the valve seat;
a valve closing member configured to abut the valve seat in a closed position and to be displaced from the valve seat in an open position, thereby releasing pressure from the fluid system;
a flow member including a stem and a flow plate, the stem being operably associated with the valve closing member and being configured to reciprocate within the guideway; and
a valve spring operably associated with the valve body, the valve spring being configured to exert a biasing force to hold the valve closing member via the flow plate against the valve seat in the closed position and to return the valve closing member to the closed position when the valve closing member is in the open position.

14. The fluid system of claim 13, wherein the fluid system is a fuel system configured to provide pressurized fuel to an internal combustion engine.

15. The fluid system of claim 13, wherein the pump is configured to pressurize the fluid to at least about 1,000 bar.

16. The fluid system of claim 13, wherein the pressure control orifice is configured to reduce the biasing force necessary to return the valve closing member to the closed position.

17. The fluid system of claim 13, wherein the pressure control orifice defines a length dimension and a diameter dimension, and wherein the length dimension and the diameter dimension are related in a ratio ranging from about two to one to about five to one.

18. The fluid system of claim 13, wherein the pressure control orifice is configured such that once the valve closing member is in the open position, the fluid flowing through the pressure control orifice cavitates, thereby creating a cavitation field that creates voids in the fluid flowing through the pressure control orifice such that the valve closing member is exposed to at least a portion of the cavitation field.

19. The fluid system of claim 13, wherein the flow plate includes at least one aperture configured to allow fluid flow across the pressure relief valve.

20. The fluid system of claim 13, wherein the stem defines at least one passage configured to provide flow communication between the pressure control orifice and the flow plate via the guideway.

21. The fluid system of claim 13, wherein the valve closing member is formed as a separate piece from the flow member.

22. The fluid system of claim 21, wherein the valve closing member is substantially ball-shaped.

23. The fluid system of claim 13, wherein the guideway defines a substantially constant cross-section.

24. The fluid system of claim 13, wherein the stem defines a portion configured to reciprocate within the guideway, the portion defining a substantially constant cross-section.

25. The fluid system of claim 13, wherein the guideway and the stem are configured such that the stem reciprocates within the guideway without becoming misaligned within the guideway.

26. A method of regulating pressure in a fluid system operably associated with a device, the method comprising:
pressurizing fluid in the fluid system via a fluid pump to a pressure above a minimum operating pressure sufficient to operate the device; and
relieving pressure via a pressure relief valve in the fluid system when the pressure in the fluid system increases to a pressure exceeding a maximum operating pressure of the device, the pressure relief valve including a pressure control orifice ending in a valve seat and a guideway extending from the valve seat,
wherein the pressure relief valve maintains the pressure in the fluid system between the minimum operating pressure and the maximum operating pressure such that the device can continue to operate.

27. The method of claim 26, wherein the fluid system includes a fuel system including fuel, and the device includes a combustion engine, the fuel system being configured to provide pressurized fuel to the combustion engine, and wherein the method includes pressurizing the fuel to a pressure above about 1,000 bar.

28. The method of claim 27, wherein the pressure relief valve is configured to operate such that the combustion engine can continue to operate as the fluid system experiences repeated occurrences of the pressure approaching the maximum operating pressure.

29. A common rail fuel system for providing pressurized fuel to a combustion engine, the system comprising:
a pump configured to pressurize fuel;
a pressure relief valve configured to regulate pressure in the system, the pressure relief valve including
a valve body defining
an inlet configured to receive fuel from the system, the inlet defining a cross-sectional area,
a pressure control orifice ending in a valve seat, the pressure control orifice defining a cross-sectional area less than the cross-sectional area of the inlet, and
a guideway extending from the valve seat;
a valve closing member configured to abut the valve seat in a closed position and to be displaced from the valve seat in an open position, thereby releasing pressure from the system;
a flow member including a stem and a flow plate, the stem being operably associated with the valve closing member and being configured to reciprocate within the guideway; and
a valve spring located in the bore, the valve spring being configured to exert a biasing force to hold the valve closing member via the flow plate against the valve seat in the closed position and to return the valve closing member to the closed position when the valve closing member is in the open position.

30. The fuel system of claim 29, wherein the pressure control orifice is configured such that once the valve closing member is in the open position, the fluid flowing through the pressure control orifice cavitates, thereby creating a cavitation field that creates voids in the fluid flowing through the pressure control orifice such that the valve closing member is exposed to at least a portion of the cavitation field.
